(19) United States
(12) Patent Application Publication
(10) Pub. No.: US 2026/0170926 A1
(43) Pub. Date: Jun. 18, 2026

(54) INSTANT-WIN DRAW LOTTERY GAMING SYSTEMS AND METHODS OF OPERATING INSTANT-WIN DRAW LOTTERY GAMING SYSTEMS

(71) Applicant: Brightstar Global Solutions Corporation, Providence, RI (US)

(72) Inventors: Joseph Charest, Attleboro, MA (US); Sarah Walker, Warwick, RI (US)

(21) Appl. No.: 18/982,057

(22) Filed: Dec. 16, 2024

(51) Int. Cl. G07F 17/32

(52) U.S. Cl. CPC G07F 17/329; G07F 17/323; G07F 17/3258

(57) ABSTRACT

An instant-win draw lottery gaming system and method of operating an instant-win draw lottery gaming system that provides players with various different lottery ticket purchase amount level, wherein higher ticket purchase amount levels provide higher odds of winning an entire progressive jackpot award amount.

### BACKGROUND

The present disclosure relates to instant-win draw lottery gaming systems and methods of operating instant-win draw lottery gaming systems that enable plays of instant-win draw lottery games.

Draw lottery gaming systems may enable a player to select numbers for a draw lottery ticket for a play of a draw lottery game. Draw lottery gaming systems may randomly draw winning numbers for the play of the draw lottery game, and if the winning drawn numbers match the player-selected numbers, may provide the player an award amount for play of the draw lottery game.

### BRIEF SUMMARY

In various embodiments, the present disclosure relates to an instant-win draw lottery gaming system including a jackpot server that maintains a progressive jackpot award amount for plays an instant-win draw lottery game, and a central server including a processor and memory device that stores a plurality of instructions, that when executed by the processor, cause the processor to communicate with lottery terminals to enable purchasers to purchases of instant-win draw lottery tickets for the plays of the instant-win draw lottery game. For each of the plays of the instant-win draw lottery game, each instant-win draw lottery ticket for that play of the instant-win draw lottery game is purchasable for any one of a plurality of different purchase amounts, each instant-win draw lottery ticket of that play of the instant-win draw lottery game has one of a plurality of different odds of winning the entire progressive jackpot award amount, each of the different odds is based on a different one of the different purchase amounts, and a determination of whether that instant-win draw lottery ticket results in a win of the entire progressive jackpot award amount is in accordance with the odds based on the purchase amount for that instant-win draw lottery ticket.

In various other embodiments, the present disclosure relates to an instant-win draw lottery gaming system including a jackpot server that maintains a progressive jackpot award amount for: plays of a first instant-win draw lottery game, and plays of a second instant-win draw lottery game that is different than the first instant draw lottery game; and a central server including a processor and memory device that stores a plurality of instructions, that when executed by the processor, cause the processor to communicate with lottery terminals to enable purchasers to purchases of instant-win draw lottery tickets for the plays of the first instant-win draw lottery game. For each of the plays of the first instant-win draw lottery game, each instant-win draw lottery ticket for that play of the first instant-win draw lottery game is purchasable for any one of a plurality of first different purchase amounts, each instant-win draw lottery ticket of that play of the first instant-win draw lottery game has one of a plurality of first different odds of winning the entire progressive jackpot award amount, wherein each of the first different odds is based on a different one of the first different purchase amounts, and wherein a determination of whether that instant-win draw lottery ticket results in a win of the entire progressive jackpot award amount is in accordance with the odds based on the purchase amount for that instant-win draw lottery ticket. The jackpot server is further configured to communicate with lottery terminals to enable purchasers to purchases of instant-win draw lottery tickets for the plays of the second instant-win draw lottery game. For each of the plays of the second instant-win draw lottery game, each instant-win draw lottery ticket for that play of the second instant-win draw lottery game is purchasable for any one of a plurality of second different purchase amounts, and each instant-win draw lottery ticket of that play of the second instant-win draw lottery game has one of a plurality of second different odds of winning the entire progressive jackpot award amount, wherein each of the second different odds is based on a different one of the second different purchase amounts, and wherein a determination of whether that instant-win draw lottery ticket results in a win of the entire progressive jackpot award amount is in accordance with the odds based on the purchase amount for that instant-win draw lottery ticket.

In various other embodiments, the present disclosure relates to an instant-win draw lottery gaming system including a jackpot server that maintains a progressive jackpot award amount for plays a plurality of instant-win draw lottery games; and a central server including a processor and memory device that stores a plurality of instructions, that when executed by the processor, cause the processor to communicate with lottery terminals to enable purchasers to purchases of instant-win draw lottery tickets for the plays of the plurality of instant-win draw lottery games. For each of the plays of the instant-win draw lottery games, each instant-win draw lottery ticket for that play of the instant-win draw lottery game is purchasable for any one of a plurality of different purchase amounts, and each instant-win draw lottery ticket of that play of the instant-win draw lottery game has one of a plurality of different odds of winning the entire progressive jackpot award amount, wherein each of the different odds is based on a different one of the different purchase amounts, and wherein a determination of whether that instant-win draw lottery ticket results in a win of the entire progressive jackpot award amount is in accordance with the odds based on the purchase amount for that instant-win draw lottery ticket. For each of the plays of one of the instant-win draw lottery games, the plurality of different purchase amount are linearly related to the plurality of different odds of winning the entire progressive jackpot award amount. For each of the plays of another one of the instant-win draw lottery games, the plurality of different purchase amounts are non-linearly related to the plurality of different odds of winning the entire progressive jackpot award amount.

Additional features are described in, and will be apparent from, the following Detailed Description and the figures.

### BRIEF DESCRIPTION OF THE SEVERAL VIEWS OF THE DRAWINGS

FIG. 1 is a front view of an example known instant-win draw lottery ticket.

FIG. 1A is a front view of part of another example known instant-win draw lottery ticket.

FIG. 1B is a front view of part of another example known instant-win draw lottery ticket.

FIG. 2 is an example known award amount configuration for an example instant-win draw lottery game.

FIG. 3 is an example known progressive jackpot award amount configuration for a pool of example instant-win draw lottery games.

FIG. 4 is an example progressive jackpot award amount configuration for a pool of example instant-win draw lottery games in accordance with one example embodiment of the present disclosure.

FIG. 5 is a front view of an example instant-win draw lottery ticket in accordance with one example embodiment of the present disclosure.

FIG. 6 is a front view of another example instant-win draw lottery ticket in accordance with one example embodiment of the present disclosure.

FIG. 7 is a front view of another example instant-win draw lottery ticket in accordance with one example embodiment of the present disclosure.

FIG. 8 is a diagrammatic view of an example instant-win draw lottery gaming system in accordance with one embodiment of the present disclosure.

### DETAILED DESCRIPTION

In various embodiments, the present disclosure relates to instant-win draw lottery gaming systems and methods of operating instant-win draw lottery gaming systems. In various embodiments, the instant-win draw lottery gaming systems are configured to, for each of a plurality of players: (1) enable a player to select any one of a plurality of different player purchase amounts for an instant-win draw lottery ticket for a play of an instant-win draw lottery game; and (2) provide the play of the instant-win draw lottery game that includes employing one of a plurality of different probabilities of winning a specific award amount (such as a progressive jackpot award amount), wherein the employed probability is respectively based on the selected player purchase amount. In various embodiments, the present disclosure also relates to instant-win draw lottery tickets generated by such instant-win draw lottery gaming systems and methods of operating such instant-win draw lottery gaming systems.

For a better understanding of the present disclosure, the following explanation regarding known instant-win draw lottery tickets and know scratch-off lottery tickets is provided.

Various known instant-win draw lottery games provided by instant-win draw lottery gaming systems provide players with instant drawn number determinations for the instant-win draw lottery tickets thereof rather than requiring the player to wait for scheduled future drawings for the plays of the draw lottery games. These instant-win draw lottery games are similar to scratch-off instant lottery games at least because they can be offered as a portfolio of different draw lottery games, they can have various different purchase amounts, they can have various different themes, and they can have various different playstyles.

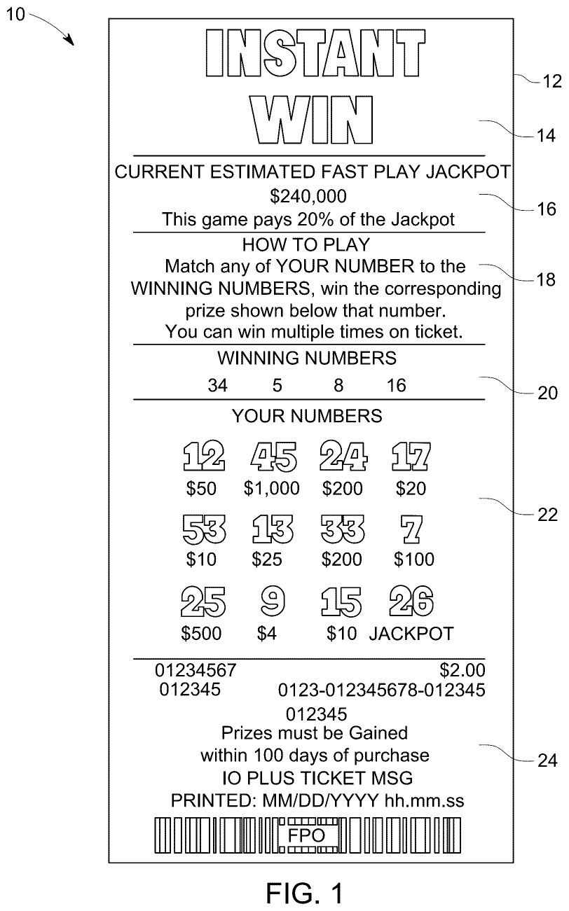

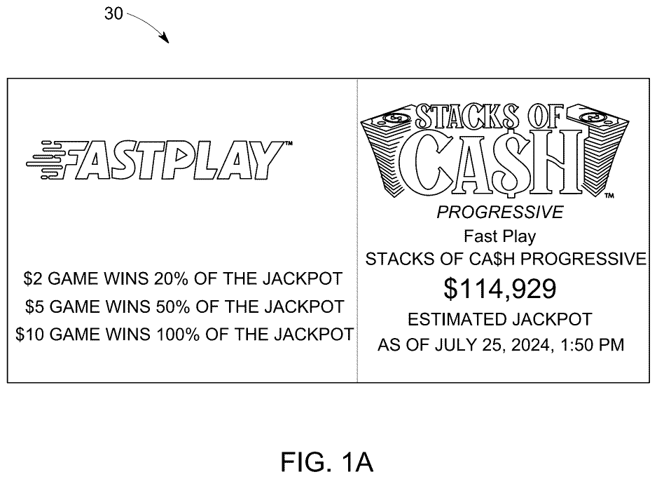

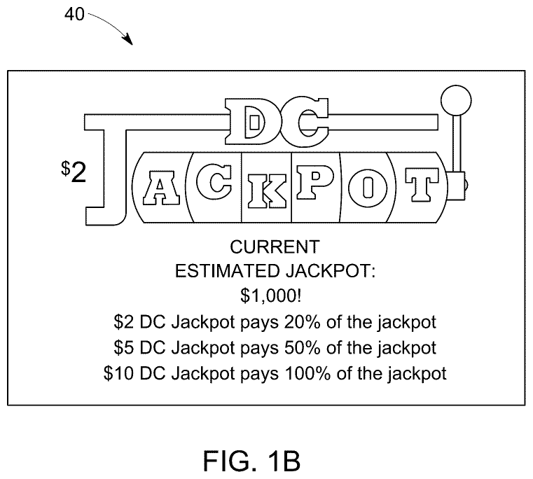

An example of an instant-win draw lottery ticket is shown in FIG. 1. This example instant-win draw lottery ticket 10 includes a substrate 12 and various instant-win draw game related data printed on the substrate 12. The various instant-win draw game related data printed on the substrate 12 include: (a) game identification section 14 that indicates the identification of the instant-win draw lottery game; (b) a progressive jackpot award amount indication section 16 that indicates an estimated amount of the progressive jackpot award amount that can be won or partially won for that game play; (c) an instruction section 18 that provides general instructions for the lottery game play; (d) a winning numbers section 20 that indicates the randomly drawn numbers for that draw lottery game play; (e) a player selected numbers section 22 that indicate the player selected numbers for that draw lottery game play; and (f) a game code and information section 24 that indicates a code (such as a bar code) that identifies the instant-win draw lottery ticket for the draw lottery game play as well as other relevant information. Based on the drawn numbers in the winning numbers section 20 and the player selected numbers in the player selected numbers section 22, the player can immediately determine if the instant-win draw lottery ticket is a winning or losing instant-win draw lottery ticket (as well as any award amount won).

Since this example instant-win draw lottery ticket for this example instant-win draw lottery game is a $2.00 instant-win draw lottery ticket as indicated by information section 24, the player can only win 20% of the jackpot as indicated by progressive jackpot award amount indication section 16 for the reasons explained in more detail below. Also for the reasons explained below, for this example instant-win draw lottery game, for a $1.00 instant-win draw lottery ticket, the player can only win 10% of the progressive jackpot award amount, for a $5.00 instant-win draw lottery ticket, the player can only win 50% of the progressive jackpot award amount, and for a $10.00 instant-win draw lottery ticket, the player can win 100% of the progressive jackpot award amount. These percentages associated with each purchase price level point can vary. For example, a lottery can provide a 100% of the progressive jackpot award amount for a $20 instant-win draw lottery ticket and a 10% of the progressive jackpot award amount for a $2 instant-win draw lottery ticket.

In certain example instant-win draw lottery games, the lottery provides a “kicker prizes” for higher purchase price levels. In one such example, a $10 instant-win draw lottery ticket is eligible for 100% of the progressive jackpot award amount, and a $20 instant-win draw lottery ticket is eligible for 100% of the progressive jackpot award amount and a static prize (such as $200,000 to $250,000). The systems and methods of the present disclosure as described herein eliminate the need for such “kicker prizes” in part because the systems and methods of the present disclosure make it much easier to provide additional price points.

Such instant-win draw lottery tickets and instant-win draw lottery games are differentiated from scratch-off instant lottery tickets and scratch-off instant ticket lottery games in various manners.

Scratch-off instant lottery games have print-runs that include a predetermined quantity scratch-off instant lottery tickets that are printed. These printed scratch-off instant lottery tickets can be sold until all of the printed lottery tickets are purchased or until the scratch-off instant lottery game (including the remaining unsold scratch-off instant lottery tickets thereof) is taken off the market.

On the other hand, instant-win draw lottery games can be implemented with a non-depleting pool of instant-win draw lottery tickets. As such, instant-win draw lottery games can include an award amount structure that is based on a grid with a predetermined set of outcomes and associated award amounts that are the same for every instant-win draw lottery ticket, and thus for every purchaser that chooses to purchase one of the instant-win draw lottery tickets of that instant-win draw lottery game.

For example, if an instant-win draw lottery game is configured with odds of 1 in 240,000 of winning the progressive jackpot award amount for that instant-win draw lottery game, each instant-win draw lottery ticket of that instant-win draw lottery game that is purchased will have the exact same odds of winning the progressive jackpot award amount (or any other award amount of the instant-win draw lottery game) as every other instant-win draw lottery ticket of that instant-win draw lottery game regardless of when that instant-win draw lottery ticket is purchased (i.e., before or after other purchases). In other words, each time a purchaser purchases an instant-win draw lottery ticket of this example instant-win draw lottery game, the instant-win draw lottery system randomly selects a unique outcome from the 240,000 different possible outcomes, and immediately replenishes such outcomes so that the next purchaser will have the same odds for each different possible award amount for that instant-win draw lottery game.

This structure differs from scratch-off instant lottery games, where a purchaser's odds to win a specific award amount changes as each of the predetermined quantity of scratch-off instant lottery tickets are sold and award amounts associated therewith are won (until ultimately all of the printed scratch-off instant lottery tickets are purchased or until the scratch-off instant lottery game is taken off the market). This also means that an instant-win draw lottery game can theoretically remain on sale in perpetuity.

Scratch-off instant lottery games often include one or more predetermined static award amounts such as the top award amounts.

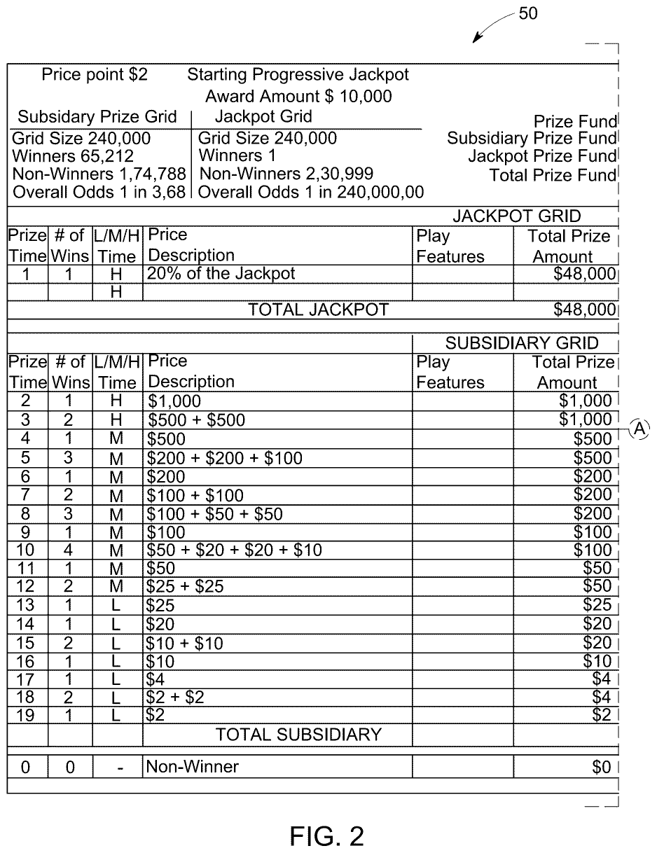

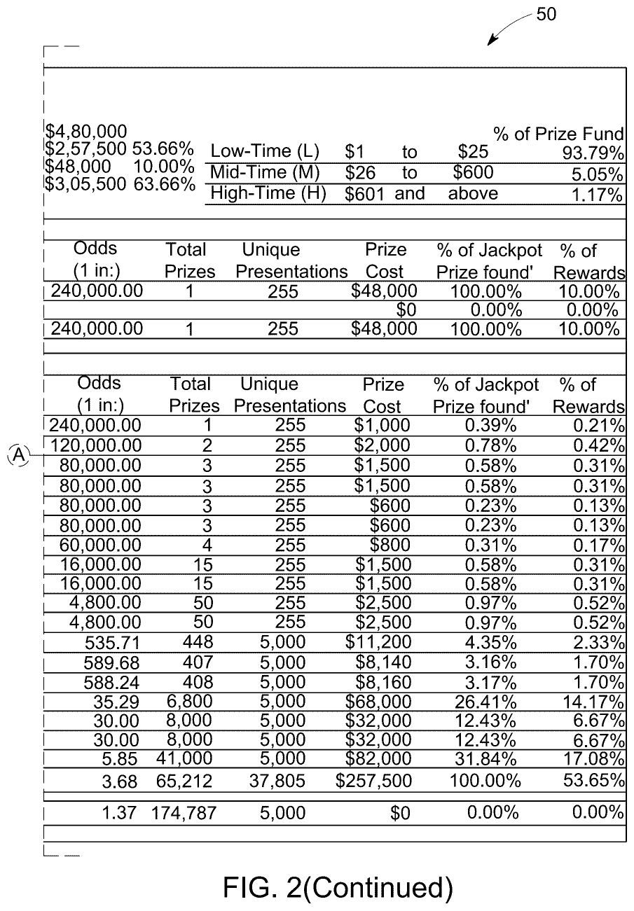

On the other hand, instant-win draw lottery games can include a progressive jackpot award amount as the top award amount. This progressive jackpot award amount for such instant-win draw lottery games can grow incrementally based on the sales of the instant-win draw lottery tickets of that instant-win draw lottery game, a subset of lottery games, or the entire lottery game portfolio. An example of such an award amount structure 50 for an instant-win draw lottery game is shown in FIG. 2. This example award amount structure 50 shown in FIG. 2 indicates that 10% of the sales of the instant-win draw lottery tickets for this instant-win draw lottery game are ear-marked to fund the progressive jackpot award amount for that instant-win draw lottery game. In one example having a progressive jackpot award shared by multiple lottery games, all of the lottery games contribute the same percentage (such as 10%) to avoid disproportionate funding. In another such example having a relatively higher purchase price level and a kicker prize, certain tickets may contribute less than 10%. For example, a $20 instant-win draw lottery ticket for a draw lottery game in a state where the $10 instant-win draw lottery ticket are eligible to win 100% of jackpot will contribute 5% of the purchase prices to grow the jackpot award and there is an additional % of sales ear-marked to fund the kicker prize (such as about ˜5%).

In various situations, the sales of instant-win draw lottery tickets from multiple instant-win draw lottery games can be pooled together to fund progressive jackpot award amounts, and each instant-win draw lottery game thereof contributes a pre-set percentage of the sales of the instant-win draw lottery tickets that are part of that instant-win draw lottery game.

It should be appreciated that FIG. 2 shows a jackpot grid and a subsidiary prize grid structure. In this example, the word “grid” represents an individual instant-win draw lottery game on the lottery system. The shared jackpot server provides a standalone grid separate from all of the individual instant-win draw lottery games on the lottery system at multiple price levels that may or may not be connected to it. When a player purchases a $10 instant-win draw lottery ticket, the lottery system first employs the jackpot grid to obtain 1 of the 240,000 outcomes (wherein 1 of the 240,000 outcomes is a winning outcome). If the obtained outcome is that winning outcome, the lottery system does not employ the subsidiary prize grid. If the obtained outcome is not that winning outcome, the lottery system employs the subsidiary prize grid, and specifically the lottery system employs the subsidiary prize grid to obtain 1 of the 240,000 outcomes of that grid (which has multiple lower amount winning outcomes such as shown in FIG. 2). It should be appreciated that the jackpot grid can be of a different grid size than subsidiary grids.

In one example pooled award amount structure: (1) a $2 instant-win draw lottery game contributing 10% means that $0.20 of every such $2 instant-win draw lottery ticket of that instant-win draw lottery game funds incrementing the progressive jackpot award amount; and (2) a $10 instant-win draw lottery game contributing 10% means that $1 of every such $10 instant-win draw lottery ticket of that instant-win draw lottery game funds incrementing the progressive jackpot award amount.

In commercially employed pooled award amount structures, all of the instant-win draw lottery tickets in each of the instant-win draw lottery games that are a part of that pool at each of the different purchase amount levels have the exact same odds of winning a proportion of the progressive jackpot award amount (such as 1 in 240,000 in the above example). This is regardless of the different purchase amount levels for each of the instant-win draw lottery tickets of such instant-win draw lottery games that contribute to the progressive jackpot award amount pool that is funded from such multiple instant-win draw games. The instant-win draw lottery purchase amount level for each instant-win draw ticket purchased determines the proportion of the progressive jackpot award amount that the purchaser of such instant-win draw ticket is eligible to win.

Continuing with the above pooled award amount structure example, (1) the purchaser of an $2 instant-win draw lottery ticket is eligible to win 20% of the progressive jackpot award amount; and (2) the purchaser of the $10 instant-win draw lottery ticket will is eligible to win 100% of the progressive jackpot award amount. In such case, if the progressive jackpot award amount is $240,000 (such as shown for the example instant-win draw lottery ticket in FIG. 1), a winning $2 ticket would be eligible to win $48,000 of the progressive jackpot award amount and a winning $10 ticket would be eligible to win the entire $240,000 of the progressive jackpot award amount. In either case, the odds of any such instant-win draw lottery ticket being a winning ticket does not change for that progressive jackpot award amount. Such fractional award amount determinations based on purchase amount levels are the current lottery industry standard when there is a shared progressive jackpot award amount for instant-win draw lottery games.

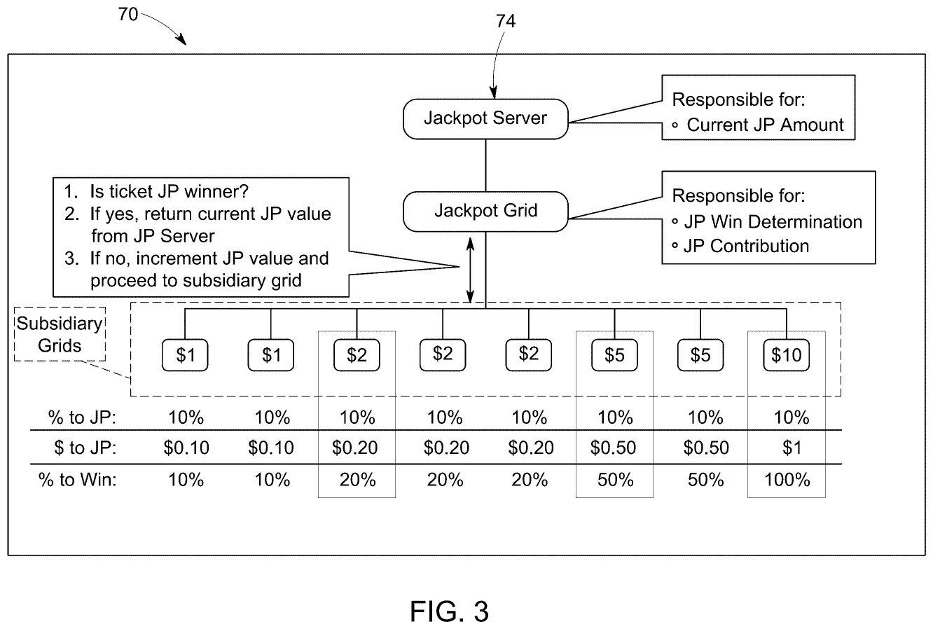

FIG. 3 shows an example win-determination process 70 for a group of known instant-win draw lottery games and an example progressive jackpot award amount structure that is shared by a group of instant-win draw lottery games (indicated by the blank squares) and outside of the individual instant-win draw lottery games.

When an instant-win draw lottery ticket from this group of instant-win draw lottery games is purchased, the central server of the instant-win draw lottery system communicates with a shared jackpot server 74, and selects a random outcome from a pool of different outcomes (240,000 outcomes in this example) to determine if that instant-win draw lottery ticket results in the progressive jackpot award amount. This jackpot win determination occurs in the shared jackpot server (such as in the jackpot grid), where a single outcome is returned before the lottery system obtains an outcome from the subsidiary grid.

In this example, if a first player purchases a $10 instant-win draw lottery ticket and the central server of the lottery system communicates with the shared jackpot server 74 and determines that that $10 ticket is not a winner of the progressive jackpot award amount, the central server of the lottery system determines that 10% of that $10 sale should be used to increment the progressive jackpot award amount, and communicates that amount to the shared jackpot server 74. The central server of the lottery system also uses the individual games'subsidiary grid and the award amount structure of that individual instant-win draw lottery game to determine whether the $10 ticket is a winning ticket of a lower-tier award amount or is not a winning ticket. On the other hand, if the central server of the lottery system and the shared jackpot server 74 determine to provide the progressive jackpot award amount for the $10 ticket, the shared jackpot server 74 reverts the progressive jackpot award amount to a starting award amount, and the central server of the does not continue to the subsidiary grid for the instant-win draw lottery game for that $10 ticket.

In this example, if a second player purchases a $5 instant-win draw lottery ticket and the central server of the lottery system communicates with the shared jackpot server 74 and determines that that $5 ticket is not a winner of the progressive jackpot award amount, the central server of the lottery system determines that 10% of that $5 sale should be used to increment the progressive jackpot award amount, and communicates that amount to the shared jackpot server 74. In this example, the second player is only eligible to win 50% of the progressive jackpot award amount. The central server of the lottery system also uses the individual games'subsidiary grid and the award amount structure of that individual instant-win draw lottery game to determine whether the $5 ticket is a winning ticket of a lower-tier award amount or is not a winning ticket. On the other hand, if the central server of the lottery system and the shared jackpot server 74 determine the $5 ticket to be a jackpot award winner, the shared jackpot server 74 awards 50% of the current jackpot award to the player, and the remaining 50% of the jackpot award is used to form a new jackpot award on the shared jackpot server. For example, if the current value of the jackpot award was $240,000, the $5 ticket winner would win $120,000 and the new jackpot award would be $120,000. The central server also does not continue to the subsidiary grid for the instant-win draw lottery game for that $5 ticket.

Thus, while all of these instant-win draw lottery games at all of the different purchase amount levels have the exact same odds (which in this example is 1 in 240,000) to win a proportion (which is at least part) of the shared progressive jackpot award amount, the respective different purchase amount levels for the instant-win draw lottery tickets determine the proportion of the progressive jackpot award amount that is eligible to be won based on that specific purchase amount level for that ticket.

FIGS. 1A and 1B show part of other know example instant-win draw lottery tickets 30 and 40 that is similar award amount structure configurations for known instant-win draw lottery games where the odds of winning a proportion (which is at least part) of an award amount are the same, but each different purchase amount level determines the respective eligibility for winning different proportions of such award amount.

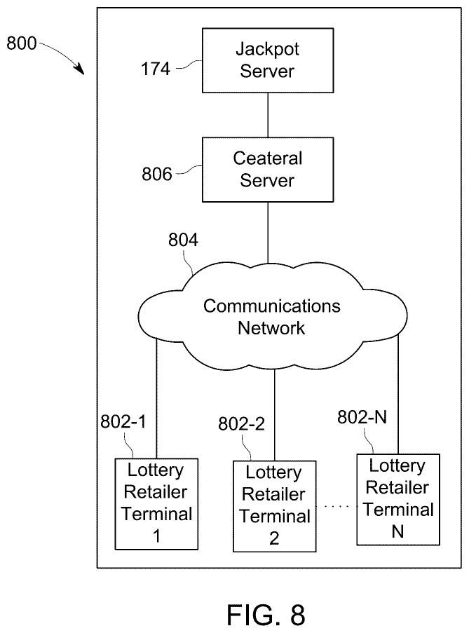

Turning now back to the present disclosure, in various embodiments, the instant-win draw lottery gaming systems and methods of operating the instant-win draw lottery gaming systems provide one or more instant-win draw lottery games that each include: (1) a plurality of different player selectable purchase amount levels for the instant-win draw lottery tickets for the instant-win draw lottery game; and (2) multiple different probabilities of winning a specific award amount (such as a progressive jackpot award amount) respectively associated with the multiple different player selectable purchase amount levels for the instant-win draw lottery tickets for the instant-win draw lottery game. The instant-win draw lottery gaming systems and methods of operating the instant-win draw lottery gaming systems thus provide one or more instant-win draw lottery games with variable odds of winning a progressive jackpot award amount for each instant-win draw lottery ticket wherein the odds employed for that ticket are based on the purchase amount level for that ticket. Various embodiments of the instant-win draw lottery gaming systems are described herein and additionally described with respect to FIG. 8.

The variable progressive jackpot award amount odds provides the players of such instant-win draw lottery games at any of the different purchase amount levels with the eligibility to win 100% of a specific award amount such as a progressive jackpot award amount. The instant-win draw lottery gaming systems provide different odds of winning the entire specific award amount such as the progressive jackpot award amount for each of the respective different purchase amount levels.

In various embodiments, the present disclosure provides the eligibility to win 100% of a specific award amount such as the progressive jackpot award amount for a single non-pooled instant-win draw lottery game.

In various embodiments, the present disclosure provides the eligibility to win 100% of a specific award amount such as the progressive jackpot award amount for a multiple pooled instant-win draw lottery games.

One example instant-win draw lottery game structure is now described with respect to three different purchase amount levels for the instant-win draw lottery tickets of an example instant-win draw lottery game in accordance with the present disclosure.

For this example instant-win draw lottery game, for a $20 instant-win draw lottery ticket, the instant-win draw lottery system will check against a $20 jackpot grid (which in this example provides odds of 1 in 100,000) for determining if that instant-win draw lottery ticket is a winner of the progressive jackpot award amount. If not, the lottery system uses 10% of the purchase amount (or $2) of that instant-win draw lottery ticket to fund the shared progressive jackpot award amount.

For this same example instant-win draw lottery game, for a $10 instant-win draw lottery ticket, the instant-win draw lottery system will check against a $10 jackpot grid (which in this example provides odds of 1 in 200,000) for determining if that instant-win draw lottery ticket is a winner of the progressive jackpot award amount. If not, the lottery system uses 10% of the purchase amount (or $1) to fund the shared progressive jackpot award amount.

For this same example instant-win draw lottery game, for a $5 instant-win draw lottery ticket, the instant-win draw lottery system will check against a $5 jackpot grid (which in this example provides odds of 1 in 400,000) for determining if that instant-win draw lottery ticket is a winner of the progressive jackpot award amount. If not, the lottery system uses 10% of the purchase amount (or $0.50) to fund the shared progressive jackpot award amount.

This example instant-win draw lottery game structure employs respective different odds for determining if that instant-win draw lottery ticket is a winner of the progressive jackpot award amount that are relatively proportional to the different purchase amount levels and that linearly change.

In various other embodiments of the present disclosure, this example instant-win draw lottery game can be structured to improve the odds as the purchase amount level increases. For example, for a $20 instant-win draw lottery ticket for the above described example instant-win draw lottery game, the lottery system can alternatively first check against a $20 jackpot grid (which in this example provides odds of 1 in 50,000) for determining if that instant-win draw lottery ticket is a winner of the progressive jackpot award amount. This can further incentivize players to move up in purchase amount levels.

In various other embodiments, this example instant-win draw lottery game better incentivize players to try instant-win draw lottery games because the relatively low purchase amount levels tend to be good entry points and provide better odds of winning the entire progressive jackpot award amount. For example, the entry-level price point for an instant-win draw lottery game can be $1 or $2, and this instant-win draw lottery game can have an accessible jackpot award for players to win such as ranging from hundreds of thousands of dollars to single-digit million dollar winning amounts.

In various other embodiments, this example instant-win draw lottery game reduces or eliminates the need for any kicker award amounts in addition to 100% of the progressive jackpot award amount for instant-win draw lottery games that have $20 or above purchase amount levels. This can also reduce the need for players to purchase multiple tickets that causes players to migrate their purchases from the $20 ticket level down to the $10 ticket level to have multiple chances of winning a portion of a higher jackpot award.

It should be appreciated that the quantity of the different purchase amount levels for instant-win draw lottery tickets for an instant-win draw lottery game in accordance with the present disclosure can vary and the respective different probabilities of winning the progressive jackpot award amount can vary in accordance with the present disclosure.

In various embodiments, as the purchase amount level increases for the instant-win draw lottery ticket of an instant-win draw lottery ticket lottery game, the odds of winning the entire progressive jackpot award amount increases linearly.

In various embodiments, as the purchase amount level increases for the instant-win draw lottery ticket of an instant-win draw lottery ticket lottery game, the odds of winning the entire progressive jackpot award amount improve partially linearly and partially non-linearly.

In various embodiments, as the purchase amount level increases for the instant-win draw lottery ticket of an instant-win draw lottery ticket lottery game, the odds of winning the entire progressive jackpot award amount improve non-linearly.

In various embodiments, as the purchase amount level increases for the instant-win draw lottery ticket of an instant-win draw lottery ticket lottery game, only the odds of winning the entire progressive jackpot award amount improve (such as where there are only two different purchase amount levels).

In various embodiments, as the purchase amount level increases for the instant-win draw lottery ticket of an instant-win draw lottery ticket lottery game, the odds of winning the entire progressive jackpot award amount improves and the odds of winning one or more other award amounts also improve.

In various embodiments, as the purchase amount level increases for the instant-win draw lottery ticket of an instant-win draw lottery ticket lottery game, the odds of winning the entire progressive jackpot award amount improves and the odds of winning each of the other award amounts also improve.

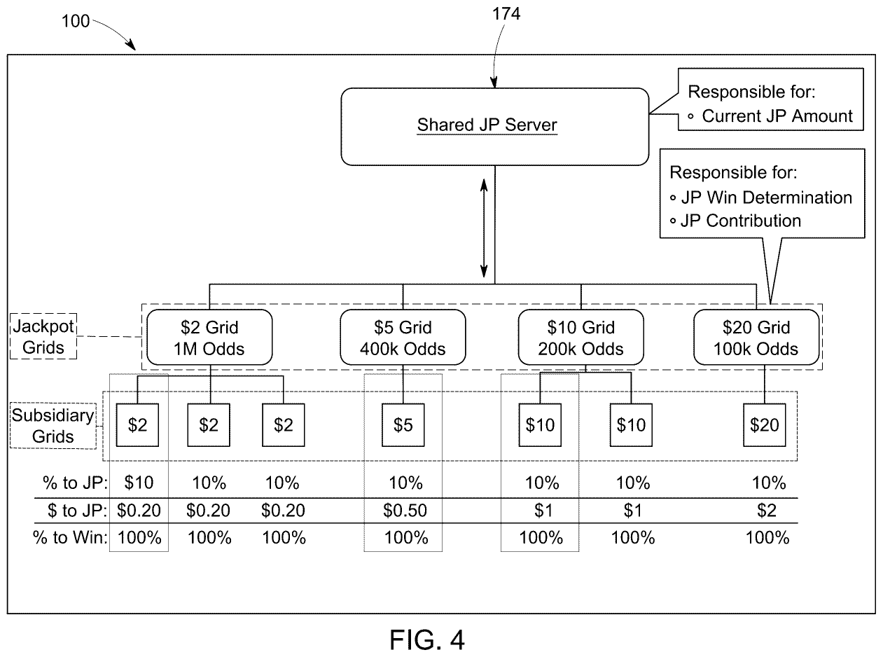

FIG. 4 shows an example of the present disclosure that includes an instant-win draw lottery gaming system and method of operating an instant-win draw lottery system that provides a win-determination process 100 for a group of instant-win draw lottery games and an example progressive jackpot award amount structure that is shared by the group of instant-win draw lottery games (indicated by the squares) and outside of the individual instant-win draw lottery games.

In the example shown in FIG. 4, the instant-win draw lottery tickets can be purchased at: (1) the $2 purchase amount level; (2) the $5 purchase amount level; (3) the $10 purchase amount level; and (4) the $20 purchase amount level. In the example shown in FIG. 4: (1) at the $2 purchase amount level for an instant-win draw lottery ticket, there is a 1/1,000,000 (“1 /M Odds”) probability of that ticket resulting in a win of the progressive jackpot award amount; (2) at the $5 purchase amount level for an instant-win draw lottery ticket, there is a 1/400,000(“400 K Odds”) probability of that ticket resulting in a win of the progressive jackpot award amount; (3) at the $10 purchase amount level for an instant-win draw lottery ticket, there is a 1/200,000 (“200 K Odds”) probability of that ticket resulting in a win of the progressive jackpot award amount; and (4) at the $20purchase amount level for an instant-win draw lottery ticket, there is a 1/100,000 (“100 K Odds”) probability of that ticket resulting in a win of the progressive jackpot award amount.

When an instant-win draw lottery ticket from as group of instant-win draw lottery games is purchased, the central server of the lottery system communicates with jackpot grid 174 and the jackpot grid 174 selects a random outcome from a pool of different outcomes (in this example) to determine if that instant-win draw lottery ticket results in the progressive jackpot award amount. This random determination is made based on the respective odds associated with the purchase amount level for the instant-win draw lottery ticket.

In this example, when a player purchases a $2 instant-win draw lottery ticket, the central server lottery system communicates with the $2 price point jackpot grid and provides an outcome indicating the $2 purchase amount level for this instant-win draw lottery ticket. The $2 price point jackpot grid randomly determines whether the $2 instant-win draw lottery ticket wins the progressive jackpot award amount using a 1/1,000,000 probability calculation. If the $2 price point jackpot grid randomly determines that this $2 instant-win draw lottery ticket wins the progressive jackpot award amount (based on the 1/1,000,000 probability calculation): (1) the $2 jackpot grid communicates that determination to the shared jackpot server 174; and (2) the shared jackpot server 174 reverts the progressive jackpot award amount to a starting award amount and does not continue to the subsidiary grid for the instant-win draw lottery game for that $2 ticket. If the $2 jackpot grid randomly determines that this $2 instant-win draw lottery ticket does not win the progressive jackpot award amount based on the 1/1,000,000 probability calculation, the $2 jackpot grid communicates that determination to the central server of the lottery system. The central server of the lottery system determines that 10% of that $2 purchase amount should used to increment the progressive jackpot award amount. The lottery system also uses the individual games'subsidiary grid and the award amount structure of that individual instant-win draw lottery game to determine whether the $2 ticket is a winning ticket of a lower-tier award amount or is not a winning ticket.

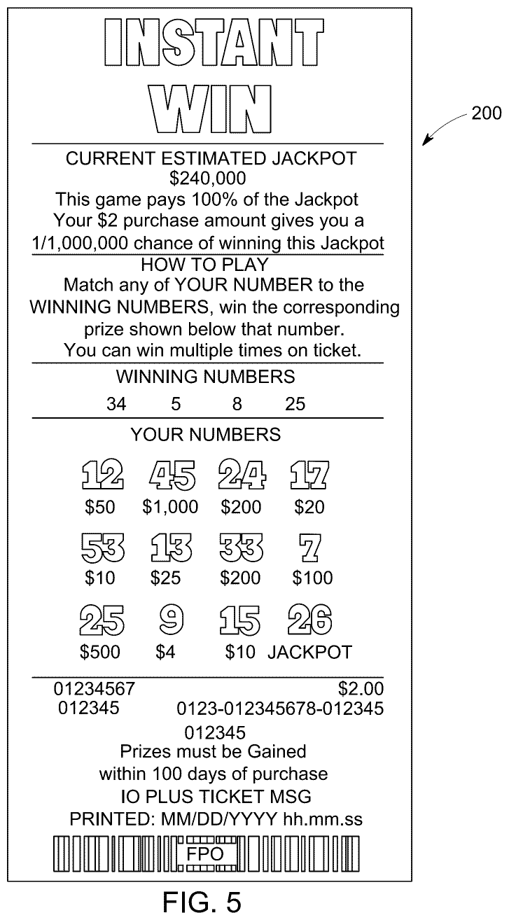

FIG. 5 shows part of an example instant-win draw lottery ticket 200 in accordance with this example embodiment of the present disclosure.

In this example, when a player purchases a $2 instant-win draw lottery ticket, the central server lottery system communicates with the shared jackpot server 174 and provides the shared jackpot server 174 with data indicating the $2 purchase amount level for this instant-win draw lottery ticket. The shared jackpot server 174 randomly determines whether the $2 instant-win draw lottery ticket wins the progressive jackpot award amount using a 1/1,000,000 probability calculation. If the shared jackpot server 174 randomly determines that this $2 instant-win draw lottery ticket wins the progressive jackpot award amount based on the 1/1,000,000 probability calculation: (1) the shared jackpot server communicates that determination to the central server of the lottery system; and (2) the shared jackpot server 174 reverts the progressive jackpot award amount to a starting award amount and does not continue to the subsidiary grid for the instant-win draw lottery game for that $2 ticket. If the shared jackpot server 174 randomly determines that this $2 instant-win draw lottery ticket does not win the progressive jackpot award amount based on the 1/1,000,000 probability calculation, the shared jackpot server communicates that determination to the central server of the lottery system. The central server of the lottery system determines that 10% of that $2 purchase amount should used to increment the progressive jackpot award amount. The lottery system also uses the individual games'subsidiary grid and the award amount structure of that individual instant-win draw lottery game to determine whether the $2 ticket is a winning ticket of a lower-tier award amount or is not a winning ticket.

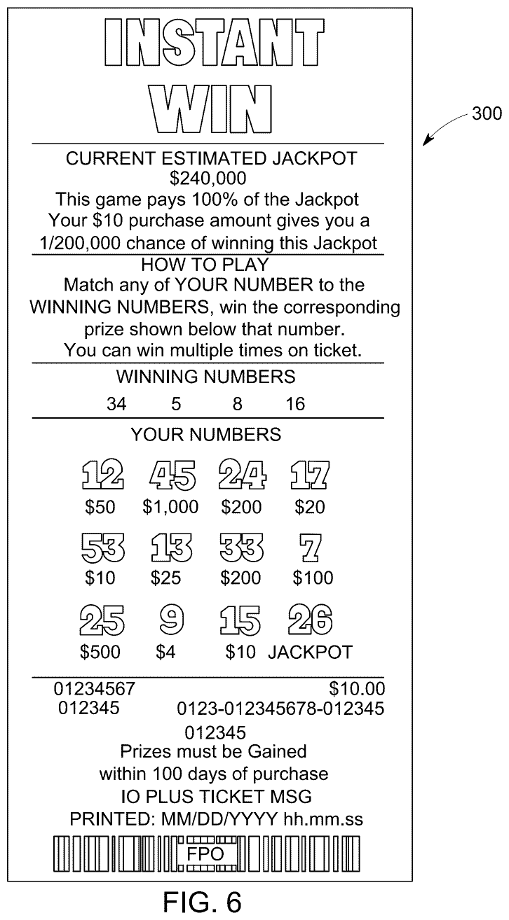

FIG. 6 shows part of an example instant-win draw lottery ticket 300 in accordance with this example embodiment of the present disclosure.

In this example, when a player purchases a $10 instant-win draw lottery ticket, the central server lottery system communicates with the shared jackpot server 174 and provides the shared jackpot server 174 with data indicating the $10 purchase amount level for this instant-win draw lottery ticket. The shared jackpot server 174 randomly determines whether the $10 instant-win draw lottery ticket wins the progressive jackpot award amount using a 1/200,000 probability calculation. If the shared jackpot server 174 randomly determines that this $10 instant-win draw lottery ticket wins the progressive jackpot award amount based on the 1/200,000 probability calculation: (1) the shared jackpot server communicates that determination to the central server of the lottery system; and (2) the shared jackpot server 174 reverts the progressive jackpot award amount to a starting award amount and does not continue to the subsidiary grid for the instant-win draw lottery game for that $10 ticket. If the shared jackpot server 174 randomly determines that this $10 instant-win draw lottery ticket does not win the progressive jackpot award amount based on the 1/200,000 probability calculation, the shared jackpot server communicates that determination to the central server of the lottery system. The central server of the lottery system determines that 10% of that $10 purchase amount should used to increment the progressive jackpot award amount. The lottery system also uses the individual games'subsidiary grid and the award amount structure of that individual instant-win draw lottery game to determine whether the $10 ticket is a winning ticket of a lower-tier award amount or is not a winning ticket.

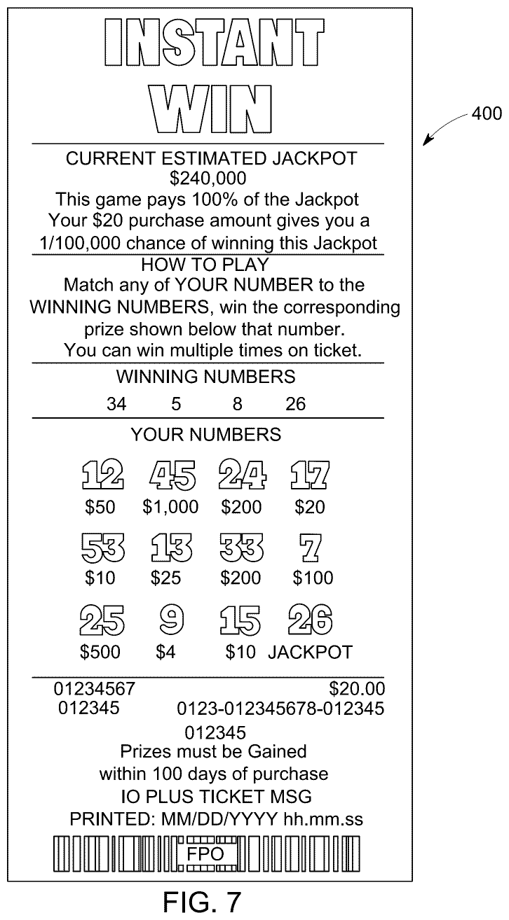

FIG. 7 shows part of an example instant-win draw lottery ticket 300 in accordance with this example embodiment of the present disclosure.

In this example, when a player purchases a $20 instant-win draw lottery ticket, the central server lottery system communicates with the shared jackpot server 174 and provides the shared jackpot server 174 with data indicating the $20 purchase amount level for this instant-win draw lottery ticket. The shared jackpot server 174 randomly determines whether the $20 instant-win draw lottery ticket wins the progressive jackpot award amount using a 1/100,000 probability calculation. If the shared jackpot server 174 randomly determines that this $20 instant-win draw lottery ticket wins the progressive jackpot award amount based on the 1/100,000 probability calculation: (1) the shared jackpot server communicates that determination to the central server of the lottery system; and (2) the shared jackpot server 174 reverts the progressive jackpot award amount to a starting award amount and does not continue to the subsidiary grid for the instant-win draw lottery game for that $20 ticket. If the shared jackpot server 174 randomly determines that this $20 instant-win draw lottery ticket does not win the progressive jackpot award amount based on the 1/100,000 probability calculation, the shared jackpot server communicates that determination to the central server of the lottery system. The central server of the lottery system determines that 10% of that $20 purchase amount should used to increment the progressive jackpot award amount. The lottery system also uses the individual games'subsidiary grid and the award amount structure of that individual instant-win draw lottery game to determine whether the $20 ticket is a winning ticket of a lower-tier award amount or is not a winning ticket.

In this example, the odds differences are non-linear based on the different purchase amount levels.

It should be appreciated that in various embodiments, the structure shown in FIG. 4 can be for a single jackpot award family within a larger portfolio that could have multiple co-existing jackpot award families at a given time. For example, there could be one jackpot award family with $2/5/10/20 price levels with their own variable odds profiles, and at the same time, there could be another jackpot award family with $10/20/30 price levels with variable jackpot odds that are different. In other words, the structure of FIG. 4 can exist multiple times within a lottery system portfolio.

It should be appreciated from the above that in various embodiments all of the instant-win draw lottery games at all of the different purchase amount levels have the different odds to win the entire shared progressive jackpot award amount, wherein the different purchase amount levels only determine the odds of winning the progressive jackpot award amount but do not determine or otherwise influence the amount eligible to be won based on the purchase amount level for that ticket. In various embodiments, the amount is always the maximum amount of the shared progressive jackpot award amount.

In various embodiments, except if the entire progressive jackpot award amount is won for an instant-win draw lottery ticket, the lottery gaming system is configured to randomly select the drawn numbers based the purchase amount level and without regard to the player selected numbers for the instant-win draw lottery ticket lottery ticket.

In various embodiments, as further described below, the instant-win draw lottery gaming system and method are configured to be provided by a lottery agency (such as a state lottery agency).

In various other embodiments, as further described below, the instant-win draw lottery gaming system and method are configured to be operated by a third party that runs the lottery for a lottery agency (such as a state lottery agency).

In various embodiments of the instant-win draw lottery gaming system, the player may purchase the lottery ticket via any suitable manner such as, but not limited to, one of the following: (1) a dedicated lottery kiosk (e.g., a lottery kiosk) configured to communicate over a data network (such as the Internet) to a lottery server (such as a central server 806 described below in connection with FIG. 8); (2) a retailer-operated lottery terminal configured to communicate over a data network (such as the Internet) to a lottery server (such as a central server 806 described below in connection with FIG. 8); (3) a personal computer configured to communicate over a data network (such as the Internet) to a lottery server (such as a central server 806 described below in connection with FIG. 8); and/or (4) a personal mobile device (such as a cellular telephone, tablet, or PDA) configured to communicate over a data network (such as a wireless or cellular data network) to a lottery server (such as a central server 806 described below in connection with FIG. 8).

It should be appreciated from the above that various embodiments of the present disclosure provide an instant-win draw lottery gaming system comprising a jackpot server that maintains a progressive jackpot award amount for plays an instant-win draw lottery game, and a central server configured to communicate with lottery terminals to enable purchasers to purchases of instant-win draw lottery tickets for the plays of the instant-win draw lottery game. For each of the plays of the instant-win draw lottery game, each instant-win draw lottery ticket for that play of the instant-win draw lottery game is purchasable for any one of a plurality of different purchase amounts, and each instant-win draw lottery ticket of that play of the instant-win draw lottery game has one of a plurality of different odds of winning the entire progressive jackpot award amount, wherein each of the different odds is based on a different one of the different purchase amounts, and wherein a determination of whether that instant-win draw lottery ticket results in a win of the entire progressive jackpot award amount is in accordance with the odds based on the purchase amount for that instant-win draw lottery ticket. In various such embodiments, for each of the plays of the instant-win draw lottery game, the plurality of different purchase amount are linearly related to the plurality of different odds of winning the entire progressive jackpot award amount. In various such embodiments, for each of the plays of the instant-win draw lottery game, the plurality of different purchase amounts are non-linearly related to the plurality of different odds of winning the entire progressive jackpot award amount. In various such embodiments, for each of the plays of the instant-win draw lottery game, if the instant-win draw lottery ticket for that play of the instant-win draw lottery game does not result in the win of the entire progressive jackpot award amount, the central server is configured to communicate data corresponding to a percentage of the purchase amount for that instant-win draw lottery ticket to the jackpot server to include the progressive jackpot award amount maintained by that jackpot server. In various such embodiments, the percentage of the purchase amount for that instant-win draw lottery ticket is the same for each of the plurality of different purchase amounts for that instant-win draw lottery ticket. In various such embodiments, for each of the plays of the instant-win draw lottery game, the plurality of different purchase amounts comprise $5, $10, and $20, and the plurality of different odds of winning the entire progressive jackpot award amount comprise: first odds associated with the $5 purchase amount, second odds associated with the $10 purchase amount, and third odds associated with the $20 purchase amount, wherein the third odds are greater than the second odds, and the second odds are greater than the first odds. In various such embodiments, for each of the plays of the instant-win draw lottery game, the plurality of different purchase amounts comprise $5, $10, and $20, and the plurality of different odds of winning the entire progressive jackpot award amount comprise: first odds associated with the $5 purchase amount, second odds associated with the $10 purchase amount, and third odds associated with the $20 purchase amount, wherein the third odds are double the second odds, and the second odds are double first odds. In various such embodiments, for each of the plays of the instant-win draw lottery game, the central server is configured to operate with one of the lottery terminals to: process data associated with of a player selection of a quantity of numbers for the instant-win draw lottery ticket for that play of the instant-win draw lottery game, process data associated with a player selection of one of the plurality of different purchase amounts for the instant-win draw lottery ticket for that play of the instant-win draw lottery game, generate the instant-win draw lottery ticket for that play of the instant-win draw lottery game, store data associated with the instant-win draw lottery ticket for that play of the instant-win draw lottery game, and cause the instant-win draw lottery ticket for that play of the instant-win draw lottery game to be provided to the player. In various such embodiments, for each of the plays of the instant-win draw lottery game, the instant-win draw lottery ticket for that play of the instant-win draw lottery game comprises an indication of the instant-win draw lottery game, an indication of the progressive jackpot award amount that can be entirely won for that play of the instant-win draw lottery game, an indication of the purchase amount for that instant-win draw lottery ticket, and an indication of the odds of winning the entire progressive jackpot award amount, an indication of each of the player numbers for the plays of the instant-win draw lottery game, and an indication of each of the drawn numbers for the play of the instant-win draw lottery game.

It should further be appreciated from the above that various embodiments of the present disclosure provide an instant-win draw lottery gaming system comprising a jackpot server that maintains a progressive jackpot award amount for plays of a first instant-win draw lottery game and plays of a second instant-win draw lottery game that is different than the first instant draw lottery game, and a central server configured to communicate with lottery terminals to enable purchasers to purchases of instant-win draw lottery tickets for the plays of the first and second instant-win draw lottery games. For each of the plays of the first instant-win draw lottery game, each instant-win draw lottery ticket for that play of the first instant-win draw lottery game is purchasable for any one of a plurality of first different purchase amounts, and each instant-win draw lottery ticket of that play of the first instant-win draw lottery game has one of a plurality of first different odds of winning the entire progressive jackpot award amount, wherein each of the first different odds is based on a different one of the first different purchase amounts, and wherein a determination of whether that instant-win draw lottery ticket results in a win of the entire progressive jackpot award amount is in accordance with the odds based on the purchase amount for that instant-win draw lottery ticket. For each of the plays of the second instant-win draw lottery game, each instant-win draw lottery ticket for that play of the second instant-win draw lottery game is purchasable for any one of a plurality of second different purchase amounts, and each instant-win draw lottery ticket of that play of the second instant-win draw lottery game has one of a plurality of second different odds of winning the entire progressive jackpot award amount, wherein each of the second different odds is based on a different one of the second different purchase amounts, and wherein a determination of whether that instant-win draw lottery ticket results in a win of the entire progressive jackpot award amount is in accordance with the odds based on the purchase amount for that instant-win draw lottery ticket. In various such embodiments, the plurality of first different purchase amounts is different than the plurality of second different purchase amounts. In various such embodiments, the plurality of first different odds is different than the plurality of second different odds. In various such embodiments, the plurality of first different purchase amounts is different than the plurality of second different purchase amounts, and wherein the plurality of first different odds is different than the plurality of second different odds. In various such embodiments, the plurality of first different purchase amounts is the same as the plurality of second different purchase amounts, and wherein the plurality of first different odds is the same as the plurality of second different odds. In various such embodiments, the plurality of first different purchase amounts is different than the plurality of second different purchase amounts, and wherein the plurality of first different odds is the same as the plurality of second different odds. In various such embodiments, the plurality of first different purchase amounts is the same as the plurality of second different purchase amounts, and wherein the plurality of first different odds is different than the plurality of second different odds. In various such embodiments, each instant-win draw lottery ticket comprises an indication of the instant-win draw lottery game, an indication of the progressive jackpot award amount that can be entirely won for that play of the instant-win draw lottery game, an indication of the purchase amount for that instant-win draw lottery ticket, and an indication of the odds of winning the entire progressive jackpot award amount, an indication of each of the player numbers for the plays of the instant-win draw lottery game, and an indication of each of the drawn numbers for the play of the instant-win draw lottery game.

It should further be appreciated from the above that various embodiments of the present disclosure provide an instant-win draw lottery gaming system comprising: a jackpot server that maintains a progressive jackpot award amount for plays a plurality of instant-win draw lottery games; and a central server configured to communicate with lottery terminals to enable purchasers to purchases of instant-win draw lottery tickets for the plays of the plurality of instant-win draw lottery games. For each of the plays of the instant-win draw lottery games, each instant-win draw lottery ticket for that play of the instant-win draw lottery game is purchasable for any one of a plurality of different purchase amounts, and each instant-win draw lottery ticket of that play of the instant-win draw lottery game has one of a plurality of different odds of winning the entire progressive jackpot award amount, wherein each of the different odds is based on a different one of the different purchase amounts, and wherein a determination of whether that instant-win draw lottery ticket results in a win of the entire progressive jackpot award amount is in accordance with the odds based on the purchase amount for that instant-win draw lottery ticket. For each of the plays of one of the instant-win draw lottery games, the plurality of different purchase amount are linearly related to the plurality of different odds of winning the entire progressive jackpot award amount, and wherein for each of the plays of another one of the instant-win draw lottery games, the plurality of different purchase amounts are non-linearly related to the plurality of different odds of winning the entire progressive jackpot award amount. In various such embodiments, for each of the plays of plurality of the instant-win draw lottery games, if the instant-win draw lottery ticket for that play of the instant-win draw lottery game does not result in the win of the entire progressive jackpot award amount, the plurality of instructions, when executed by the processor, cause the processor to: communicate data corresponding to a percentage of the purchase amount for that instant-win draw lottery ticket to the jackpot server to includes the progressive jackpot award amount maintained by that jackpot server. In various such embodiments, for each of the plays of the plurality of instant-win draw lottery games, the instant-win draw lottery ticket for that play of the instant-win draw lottery game comprises an indication of the instant-win draw lottery game, an indication of the progressive jackpot award amount that can be entirely won for that play of the instant-win draw lottery game, an indication of the purchase amount for that instant-win draw lottery ticket, and an indication of the odds of winning the entire progressive jackpot award amount, an indication of each of the player numbers for the plays of the instant-win draw lottery game, and an indication of each of the drawn numbers for the play of the instant-win draw lottery game.

### Example Lottery Gaming Systems—General

As mentioned above, in various embodiments, the instant-win draw lottery gaming system and method of the present disclosure are configured to be operated by a lottery agency (such as a state lottery agency).

As mentioned above, in various other embodiments, the instant-win draw lottery gaming system and method of the present disclosure are configured to be operated by a third party that runs the lottery for a lottery agency (such as a state lottery agency).

FIG. 8 illustrates an example networked lottery gaming system 800 for either implementation. This example network instant-win draw lottery gaming system 800 generally includes: (1) a plurality of lottery retailer terminals 802-1 to 802-N; (2) a communications network 804; (3) one or more central servers such as central server 806; and (4) the jackpot server 174 (such as described above). Generally, the retailer terminals 802-1 to 802-N and the central server 806 are configured to perform the functions described above and further described below.

In this example embodiment, each retailer terminal 802 corresponds to (or is associated with) a particular lottery retailer. For example, the first retailer terminal 802-1 of FIG. 8 may be associated with a first lottery retailer, such as a convenience store, and the second retailer terminal 802-2 of FIG. 8 may be associated with a second lottery retailer, such as a supermarket. It should be understood that any suitable quantity of lottery retailer terminals may be employed in the lottery gaming system 800, along with any suitable quantity of corresponding central servers 806.

In various example embodiments, the lottery retailer terminal 802 includes one or more processor(s). Generally, the processor is operative to perform or process instructions, and in particular, to operate in accordance with the various methods described herein. For example, the processor of the lottery retailer terminal 802 may be operable to enable the lottery retailer terminal 802 to transmit data to (and receive data from) the central server 806. More specifically, the processor may enable the transmission of data representing each lottery ticket.

In various example embodiments, the lottery retailer terminal 802 includes one or more input device(s). The input devices of the lottery retailer terminal 802 may include components such as an optical scanner and/or a barcode scanner, for reading and/or for deriving information associated with a playslip and/or a lottery ticket. For example, a lottery ticket may include registration marks, authenticity data, various codes, micro-printed indicia, one or more sense marks, and/or other lottery indicia that must be read. Examples of additional input devices include, but are not limited to, a keypad, a mouse, an image capturing device (e.g., an optical character recognition (OCR) device), a biometric reader, a portable storage device (e.g., a memory stick), and the like.

In various example embodiments, the input device(s) of the lottery retailer terminal 802 may include a clock. The clock may be employed to detect, derive and/or append time and/or date information for use by the central server 806 to: (i) create a data record corresponding to lottery tickets purchased at the lottery retailer terminal 802, (ii) to determine redemption time, round and/or date information associated with lottery tickets, and/or (iii) determine whether a lottery player has redeemed their lottery ticket in a manner that qualifies the player to receive a particular redemption or settlement value (for example, if the player makes a lottery ticket redemption request prior to the revealing of a full lottery outcome).

In various example embodiments, the lottery retailer terminal 802 includes one or more output device(s). Such output device(s) may include such components as a display for outputting information to a lottery player or to a terminal operator (e.g., win/loss information and/or payout amounts), one or more benefit output devices (e.g., a cash drawer, a currency dispenser), a printer for producing a physical record (e.g., paper slip, receipt, ticket, voucher, coupon, etc.) that defines a lottery ticket, audio/video output device(s), and the like.

In various example embodiments, the lottery retailer terminal 802 also includes one or more communications port(s), such as a serial port, a modem or the like. Generally, the communications port of the lottery retailer terminal 802 may be operable to facilitate two-way data communications between (i) the lottery retailer terminal 802, and (ii) the central server 806. In accordance with some embodiments, the communications port of the lottery retailer terminal 802 may operate to facilitate the transmission of information between the lottery retailer terminal and a player device such as a personal digital assistant (PDA), cell phone and/or a dedicated (e.g., a proprietary) device.

In various example embodiments, the lottery retailer terminal 802 includes a data storage device such as a hard disk, optical or magnetic media, random access memory (RAM) and/or read-only memory (ROM), or the like memory device. Generally, the data storage device of the lottery retailer terminal 802 stores a software program, the software program enabling a processor of the retailer terminal 802 to perform various functions including some or all of the various steps described herein. For example, as noted above with respect to FIGS. 1 to 7, in accordance with certain embodiments, the lottery retailer terminal 802 may be configured to perform some or all of the functions of the central server 806 (and vice versa) such that the central server 806 and the lottery retailer terminal 802 may be considered as the same “device.”

In various example embodiments, a lottery sales device may be utilized in place of a lottery retailer terminal 802. Such a lottery sales device may be implemented as a lottery server, a controller, a dedicated hardware circuit, an appropriately programmed general-purpose computer, or any other equivalent electronic, mechanical or electro-mechanical device. Thus, in various embodiments, a lottery sales device may include, for example, but is not limited to: (1) a video lottery terminal that may include a touch sensitive screen for use by a player; (2) a personal computer (e.g., which communicates with a remote lottery server); or (3) a personal mobile device such as a mobile telephone, a tablet, or a personal digital assistant. The lottery sales device may include any or all of the devices of the aforementioned systems.

In this example embodiment, the central server 806 operates to: (1) receive and/or store data associated with one or more instant-win draw lottery tickets including such data as: (a) ticket identifier(s), and (b) ticket indicia; (2) determine at least a first redemption value associated with an instant-win draw lottery ticket; (3) receive a redemption request associated with the instant-win draw lottery ticket; (4) determine a time of play associated with the redemption request; and (5) transmit an indication of the appropriate redemption value to a lottery retailer terminal (e.g., for output or display to a lottery player and/or lottery terminal operator).

In various example embodiments, the central server 806 includes one or more processor(s). Such a processor functions to process instructions, and in particular, to operate in accordance with various methods described herein. For example, the processor may operate to enable the central server 806 to transmit data to (and receive data from) the lottery retailer terminal 802. More specifically, the processor of the central server 806 may enable the transmission of data representing a lottery ticket, as well as information defining one or more payout(s) associated with that lottery ticket to or by a specific one of the lottery retailer terminals 802 shown in the lottery network 800 of FIG. 8. Thus, the central server 806 may be implemented as a system controller, a dedicated hardware circuit, an appropriately and particularly programmed general-purpose computer, or any other equivalent electronic, mechanical or electro-mechanical device capable of providing for one or more of the embodiments described herein.

In various example embodiments, the central server 806 includes one or more input device(s). Examples of such input devices include a keypad, a mouse, a touch-screen, a random number generator, a microphone, and other digital or analog input devices.

In various example embodiments, the central server 806 also includes one or more output device(s). Example of output device(s) of the central server 806 include a monitor or other display for outputting information to an operator of the central server 806 (e.g., for displaying information such as statistical or sales data, win and loss information and/or payout amounts), a printer for producing a physical record (e.g., a report) of such data, and the like. In addition, the central server 806 may include one or more communications ports, such as a serial port, modem or the like, operable to facilitate two-way data communications between (i) the central server 806 and (ii) one or more lottery retailer terminals 802.

In various example embodiments, the central server 806 includes a data storage device (e.g., a hard disk or hard drive, a media-based (removable) memory, or the like). In certain embodiments, the data storage device of the central server 806 stores at least one software program, which includes a program to enable the processor of the central server 806 to perform some or all of the various steps and functions of at least one implementation of the methods described in detail herein. In addition, the data storage device of the central server 806 may operate to store one or more databases including a lottery ticket database and a lottery ticket redemption status database.

In various example embodiments, the central server 806 includes a lottery ticket server device that is located at a lottery ticket printing facility, and may also function to manage the ticket printing process. The central server 806 may also function to develop a lottery game matrix (e.g., determining base payouts, win frequencies, and the like) and to match static lottery content with secure paytable (or payout distribution) data. In certain embodiments, a lottery ticket printer device for use in such lottery gaming systems may utilize the game matrix information from the central server and may apply it to the secure paytable data.

In certain example embodiments, a retailer terminal (such as the first retailer terminal 802-1) of FIG. 8 is configured to perform some or all of the functions of the central server 806. Thus, in certain example embodiments, the central server 806 and the retailer terminal (such as the first retailer terminal 802-1) (or another given retailer terminal and server pairing) may be considered as the same “device.”

Generally, the communications network 804 of FIG. 8 includes one or more local and/or wide-area network(s) proprietary and/or public network(s) (e.g., the Internet) for facilitating two-way data communications between the retailer terminals 802 and the central server 806. The central server 806 may communicate with lottery retailer terminals 802 directly or indirectly, via a wired or wireless medium, such as via the Internet, via a local area network (LAN), via a wide area network (WAN), via an Ethernet, via a Token Ring, via a telephone line, via a cable line, via a radio channel, via an optical communications line, via a satellite communications link, or via any other appropriate communications system or combinations thereof. Any number and type of devices may be in communication with the central server 806, and communication between the lottery retailer terminals 802 and the central server 806 may be direct or indirect. A variety of communications protocols may be part of any such communications system, including, but not limited to: Ethernet (or IEEE 802.3), SAP, ATP, Bluetooth™, and TCP/IP.

It should be understood that devices in communication with each other need not be continually transmitting to each other. On the contrary, such devices need only transmit to each other as necessary, and may actually refrain from exchanging data most of the time. For example, a device in communication with another device via the Internet may not transmit data to the other device for days or weeks at a time. In some embodiments, a server may not be necessary and/or preferred. For example, in one or more embodiments, methods described herein may be practiced on a stand-alone gaming device and/or a gaming device in communication only with one or more other gaming devices. In such an embodiment, any functions described as performed by the computer may instead be performed by one or more gaming devices.

As used herein, a lottery retailer may include a merchant who sells lottery tickets at a particular location, authenticates winning lottery tickets, redeems authenticated winning lottery tickets, and/or provides awards to players for winning lottery tickets. Examples of various lottery retailers include, but are not limited to, convenience stores, gas stations, supermarkets, and gaming establishments.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. An instant-win draw lottery gaming system comprising:
a jackpot server that maintains a progressive jackpot award amount for plays an instant-win draw lottery game; and
a central server including a processor and memory device that stores a plurality of instructions, that when executed by the processor, cause the processor to:
communicate with lottery terminals to enable purchasers to purchases of instant-win draw lottery tickets for the plays of the instant-win draw lottery game,
wherein for each of the plays of the instant-win draw lottery game,
each instant-win draw lottery ticket for that play of the instant-win draw lottery game is purchasable for any one of a plurality of different purchase amounts, and
each instant-win draw lottery ticket of that play of the instant-win draw lottery game has one of a plurality of different odds of winning the entire progressive jackpot award amount,
wherein each of the different odds is based on a different one of the different purchase amounts, and
wherein a determination of whether that instant-win draw lottery ticket results in a win of the entire progressive jackpot award amount is in accordance with the odds based on the purchase amount for that instant-win draw lottery ticket.

2. The instant-win draw lottery gaming system of claim 1, wherein for each of the plays of the instant-win draw lottery game, the plurality of different purchase amount are linearly related to the plurality of different odds of winning the entire progressive jackpot award amount.

3. The instant-win draw lottery gaming system of claim 1, wherein for each of the plays of the instant-win draw lottery game, the plurality of different purchase amounts are non-linearly related to the plurality of different odds of winning the entire progressive jackpot award amount.

4. The instant-win draw lottery gaming system of claim 1, wherein for each of the plays of the instant-win draw lottery game, if the instant-win draw lottery ticket for that play of the instant-win draw lottery game does not result in the win of the entire progressive jackpot award amount, the plurality of instructions, when executed by the processor, cause the processor to: communicate data corresponding to a percentage of the purchase amount for that instant-win draw lottery ticket to the jackpot server to include the progressive jackpot award amount maintained by that jackpot server.

5. The instant-win draw lottery gaming system of claim 4, wherein the percentage of the purchase amount for that instant-win draw lottery ticket is the same for each of the plurality of different purchase amounts for that instant-win draw lottery ticket.

6. The instant-win draw lottery gaming system of claim 1, wherein for each of the plays of the instant-win draw lottery game, the plurality of different purchase amounts comprise $5, $10, and $20, and the plurality of different odds of winning the entire progressive jackpot award amount comprise: first odds associated with the $5 purchase amount, second odds associated with the $10 purchase amount, and third odds associated with the $20 purchase amount, wherein the third odds are greater than the second odds, and the second odds are greater than the first odds.

7. The instant-win draw lottery gaming system of claim 1, wherein for each of the plays of the instant-win draw lottery game, the plurality of different purchase amounts comprise $5, $10, and $20, and the plurality of different odds of winning the entire progressive jackpot award amount comprise: first odds associated with the $5 purchase amount, second odds associated with the $10 purchase amount, and third odds associated with the $20 purchase amount, wherein the third odds are double the second odds, and the second odds are double first odds.

8. The instant-win draw lottery gaming system of claim 1, wherein for each of the plays of the instant-win draw lottery game, the central server is configured to operate with one of the lottery terminals to:
process data associated with of a player selection of a quantity of numbers for the instant-win draw lottery ticket for that play of the instant-win draw lottery game,
process data associated with a player selection of one of the plurality of different purchase amounts for the instant-win draw lottery ticket for that play of the instant-win draw lottery game,
generate the instant-win draw lottery ticket for that play of the instant-win draw lottery game,
store data associated with the instant-win draw lottery ticket for that play of the instant-win draw lottery game, and
cause the instant-win draw lottery ticket for that play of the instant-win draw lottery game to be provided to the player.

9. The instant-win draw lottery gaming system of claim 8, wherein for each of the plays of the instant-win draw lottery game, the instant-win draw lottery ticket for that play of the instant-win draw lottery game comprises an indication of the instant-win draw lottery game, an indication of the progressive jackpot award amount that can be entirely won for that play of the instant-win draw lottery game, an indication of the purchase amount for that instant-win draw lottery ticket, and an indication of the odds of winning the entire progressive jackpot award amount, an indication of each of the player numbers for the plays of the instant-win draw lottery game, and an indication of each of the drawn numbers for the play of the instant-win draw lottery game.

10. An instant-win draw lottery gaming system comprising:
a jackpot server that maintains a progressive jackpot award amount for:
plays of a first instant-win draw lottery game, and
plays of a second instant-win draw lottery game that is different than the first instant draw lottery game; and
a central server including a processor and memory device that stores a plurality of instructions, that when executed by the processor, cause the processor to:
communicate with lottery terminals to enable purchasers to purchases of instant-win draw lottery tickets for the plays of the first instant-win draw lottery game,
wherein for each of the plays of the first instant-win draw lottery game,
each instant-win draw lottery ticket for that play of the first instant-win draw lottery game is purchasable for any one of a plurality of first different purchase amounts, and
each instant-win draw lottery ticket of that play of the first instant-win draw lottery game has one of a plurality of first different odds of winning the entire progressive jackpot award amount,
wherein each of the first different odds is based on a different one of the first different purchase amounts, and
wherein a determination of whether that instant-win draw lottery ticket results in a win of the entire progressive jackpot award amount is in accordance with the odds based on the purchase amount for that instant-win draw lottery ticket; and
communicate with lottery terminals to enable purchasers to purchases of instant-win draw lottery tickets for the plays of the second instant-win draw lottery game,
wherein for each of the plays of the second instant-win draw lottery game,
each instant-win draw lottery ticket for that play of the second instant-win draw lottery game is purchasable for any one of a plurality of second different purchase amounts, and
each instant-win draw lottery ticket of that play of the second instant-win draw lottery game has one of a plurality of second different odds of winning the entire progressive jackpot award amount,
wherein each of the second different odds is based on a different one of the second different purchase amounts, and
wherein a determination of whether that instant-win draw lottery ticket results in a win of the entire progressive jackpot award amount is in accordance with the odds based on the purchase amount for that instant-win draw lottery ticket.

11. The instant-win draw lottery gaming system of claim 10, wherein the plurality of first different purchase amounts is different than the plurality of second different purchase amounts.

12. The instant-win draw lottery gaming system of claim 10, wherein the plurality of first different odds is different than the plurality of second different odds.

13. The instant-win draw lottery gaming system of claim 10, wherein the plurality of first different purchase amounts is different than the plurality of second different purchase amounts, and wherein the plurality of first different odds is different than the plurality of second different odds.

14. The instant-win draw lottery gaming system of claim 10, wherein the plurality of first different purchase amounts is the same as the plurality of second different purchase amounts, and wherein the plurality of first different odds is the same as the plurality of second different odds.

15. The instant-win draw lottery gaming system of claim 10, wherein the plurality of first different purchase amounts is different than the plurality of second different purchase amounts, and wherein the plurality of first different odds is the same as the plurality of second different odds.

16. The instant-win draw lottery gaming system of claim 10, wherein the plurality of first different purchase amounts is the same as the plurality of second different purchase amounts, and wherein the plurality of first different odds is different than the plurality of second different odds.

17. The instant-win draw lottery gaming system of claim 10, wherein each instant-win draw lottery ticket comprises an indication of the instant-win draw lottery game, an indication of the progressive jackpot award amount that can be entirely won for that play of the instant-win draw lottery game, an indication of the purchase amount for that instant-win draw lottery ticket, and an indication of the odds of winning the entire progressive jackpot award amount, an indication of each of the player numbers for the plays of the instant-win draw lottery game, and an indication of each of the drawn numbers for the play of the instant-win draw lottery game.

18. An instant-win draw lottery gaming system comprising:
a jackpot server that maintains a progressive jackpot award amount for plays a plurality of instant-win draw lottery games; and
a central server including a processor and memory device that stores a plurality of instructions, that when executed by the processor, cause the processor to:
communicate with lottery terminals to enable purchasers to purchases of instant-win draw lottery tickets for the plays of the plurality of instant-win draw lottery games,
wherein for each of the plays of the instant-win draw lottery games,
each instant-win draw lottery ticket for that play of the instant-win draw lottery game is purchasable for any one of a plurality of different purchase amounts, and
each instant-win draw lottery ticket of that play of the instant-win draw lottery game has one of a plurality of different odds of winning the entire progressive jackpot award amount,
wherein each of the different odds is based on a different one of the different purchase amounts, and
wherein a determination of whether that instant-win draw lottery ticket results in a win of the entire progressive jackpot award amount is in accordance with the odds based on the purchase amount for that instant-win draw lottery ticket;
wherein for each of the plays of one of the instant-win draw lottery games, the plurality of different purchase amount are linearly related to the plurality of different odds of winning the entire progressive jackpot award amount, and
wherein for each of the plays of another one of the instant-win draw lottery games, the plurality of different purchase amounts are non-linearly related to the plurality of different odds of winning the entire progressive jackpot award amount.

19. The instant-win draw lottery gaming system of claim 18, wherein for each of the plays of plurality of the instant-win draw lottery games, if the instant-win draw lottery ticket for that play of the instant-win draw lottery game does not result in the win of the entire progressive jackpot award amount, the plurality of instructions, when executed by the processor, cause the processor to: communicate data corresponding to a percentage of the purchase amount for that instant-win draw lottery ticket to the jackpot server to includes the progressive jackpot award amount maintained by that jackpot server.

20. The instant-win draw lottery gaming system of claim 18, wherein for each of the plays of the plurality of instant-win draw lottery games, the instant-win draw lottery ticket for that play of the instant-win draw lottery game comprises an indication of the instant-win draw lottery game, an indication of the progressive jackpot award amount that can be entirely won for that play of the instant-win draw lottery game, an indication of the purchase amount for that instant-win draw lottery ticket, and an indication of the odds of winning the entire progressive jackpot award amount, an indication of each of the player numbers for the plays of the instant-win draw lottery game, and an indication of each of the drawn numbers for the play of the instant-win draw lottery game.
